(19) United States
(12) Patent Application Publication
(10) Pub. No.: US 2026/0330527 A1
(43) Pub. Date: Oct. 22, 2026

(54) AI-Augmented Integrated Product and Service Packages

(71) Applicant: KPMG International Services Ltd, London (GB)

(72) Inventors: Jitz Desai, London (GB); Eric Rose, Philadelphia, PA (US); Parama Bhattacharya, Bangalore (IN); Hardeep Sangwan, Pune (IN)

(73) Assignee: KPMG International Services Ltd, London (GB)

(21) Appl. No.: 19/182,792

(22) Filed: Apr. 18, 2025

(51) Int. Cl. G06Q 30/0601; G06Q 10/20

(52) U.S. Cl. CPC G06Q 30/0631; G06Q 10/20

(57) ABSTRACT

Systems and methods for using artificial intelligence (AI) to generate optimized product and service recommendations to customers. A method includes generating a plurality of customer profiles using a first AI model based on ingested customer data, generating a plurality of product and service offerings using a second AI model based on ingested manufacturer vehicle data, and for a given customer, generating a plurality of recommended products and services using a third AI model based on the given customer profile, the other of the plurality of customer profiles, and the plurality of product and service offerings.

### BACKGROUND

This disclosure generally relates to systems and methods for recommending vehicles, vehicle products and enhancements, services, and the like and, more particularly, to using generative artificial intelligence (generative AI) models to evaluate and recommend vehicles, vehicle products and enhancements, services, and the like.

Recently, the automotive industry, including component manufacturers, vehicle manufacturers, design engineers, marketing and finance executives, investors, dealers, and customers, have been confronted with massive change. Future success for manufacturers will be determined by their ability to adapt to multiple categories of change that require strategic response, specific capabilities, and changes to business and operating models.

First, the shift to electric power trains leaves traditional internal combustion engine automakers pursuing electric vehicle strategies while facing new competitors. Vehicles have become connected, with processors that improve vehicle performance and provide a new kind of experience, including driverless rides. Second, the shift to EVs requires new ways of building vehicles with completely different components and technologies. Plants and processes optimized for ICE vehicles need to be revised and new and different partnerships are emerging to that end. Third, new ownership and usage models like ride hailing, ride sharing, and subscriptions continue to gain traction, with vehicles used on an “as-a-service” basis. Fourth, consumers have been shopping for cars online for years. Now, they want to complete all of their vehicle-related transactions online. In addition, new manufacturers are selling directly to consumers rather than using the dealer-centric model. Fifth, policy and regulatory changes are critical to the transition to EVs. Many countries and states have set deadlines for ending ICE vehicle sales.

In addition, market and customer related developments create significant challenges for vehicle manufacturers. First through increasing competitive pressure from a variety of new technology companies and emerging manufacturers and due to reduced demand owing to inflation, higher financing costs, and reduced EV subsidies. Heavy investment in new technologies also squeezes profit margins. Manufacturers are also challenged by a decrease in customer brand loyalty and rising customer expectations.

Considering these challenges, manufacturer offerings including products or services can contribute significantly to their profitability and, thus, manufacturers should consider vehicle product or service sales channels important for increasing these sales or licensing transactions.

### SUMMARY OF THE INVENTION

Systems and methods are described for using artificial intelligence (AI) to generate optimized product and service recommendations to customers. A method includes generating a plurality of customer profiles using a first AI model based on ingested customer data, generating a plurality of product and service offerings using a second AI model based on ingested manufacturer vehicle data, and for a given customer, generating a plurality of recommended products and services using a third AI model based on the given customer profile, the other of the plurality of customer profiles, and the plurality of product and service offerings.

### BRIEF DESCRIPTION OF DRAWINGS

The present invention is described by way of example and not limited to the accompanying figures in which like reference numbers indicate similar elements and in which:

FIG. 1 is a logical flow diagram of an exemplary method for vehicle product and service recommendation;

FIG. 2 is a diagram of an example system for vehicle product and service recommendation;

FIG. 3 is a logical architecture of the modules shown in FIG. 2;

FIG. 4 is a flowchart illustrating an example method for vehicle product and service recommendation using the system and architecture shown in FIGS. 1-3; and

FIG. 5 is a block diagram of an example machine for use in the devices and system shown in FIGS. 2-4.

### DETAILED DESCRIPTION OF THE INVENTION

In the following description of embodiment of the invention, reference is made to the accompanying figures, which show by way of illustration embodiment in which aspects of the disclosure may be practiced. Other embodiments may be used, and structural or functional modifications may be made without departing from the scope of the present disclosure. Aspects of the disclosure are capable of other embodiments and of being practiced in various ways. In addition, the terminology used in this disclosure is for the purpose of description and should not be regarded as limiting. Rather, the phrases and terms used should be given their broadest interpretation and meaning.

Considering the challenges outlined above, as well as the potential for input prices to increase and the need for retail prices to drop at times, manufacturers are frequently faced with profit margin depression. They may thus seek to maintain or increase profitability by selling vehicle products or services to customers, such as maintenance plans or services, on-demand access to vehicles, newly offered software-based services, and the like. These offerings may be made at specific times (e.g., when a vehicle reaches a certain mileage or is in need of routine maintenance) or locations (e.g., when a consumer is at a big box retailer or boat dealer and may need additional carrying capacity or towing ability). Manufacturers may also wish to offer new as-a-service services such as time or milage based pricing, insurance bundles, subscriptions to mobility services (including owner lending programs in cooperation with ride-sharing services), and the like.

The invention uses artificial intelligence (AI) to perform many of the novel aspects described herein. The invention may use a single or multiple AI models, which may be different types of AI (i.e., machine learning, deep neural networks, long short-term memory, and generative transformers) to perform various steps, although it should be understood that no particular step may only be performed by the specified AI model type. Thus, the invention does not simply automate steps of a manual process using general purpose computers. Rather, the invention requires multiple AI models, including different types of AI models in a chained fashion, to analyze volumes of data to generate recommendations that are optimized for acceptance by customers.

Illustrative embodiments of the enhanced systems and methods described herein are generally directed to automating and enhancing a computer-based system for determining optimal product and service offerings from manufacturers and/or vehicle dealers to customers. These functions have traditionally been done, if at all, across all current, past, and potential customers without considering the applicability of such offerings to any given customer or their vehicle. For example, given only data passively collected and not input by a customer, a computer system may analyze the data and recommend a product or service that will most likely result in purchase or license by the customer, removing human bias, efficiently increasing manufacturer and dealer profit, and improving overall customer experience.

Example embodiments of the invention relate to systems and methods for using AI models to evaluate and recommend vehicle products or services. More particularly, embodiments describe systems and methods for using AI to generate optimized product and service recommendations to customers. For example, a method includes steps of generating a plurality of customer profiles using a first AI model based on ingested customer data, generating a plurality of product and service offerings using a second AI model based on ingested manufacturer vehicle data, and for a given customer, generating a plurality of recommended products and services using a third AI model based on the given customer profile, the other of the plurality of customer profiles, and the plurality of product and service offerings. The suggested products and services may include new infotainment service subscriptions, vehicle service recommendations, vehicle accessory recommendations, new vehicle lease or purchase recommendations, ride-share service recommendations, or any other suitable suggestions to enhance customer experience with the manufacturer and dealer.

The types of data that may be analyzed by the AI models include customer demographic data, customer financial data, core vehicle data, and vehicle use data, among other types of data. Customer demographic data could include name, age, date of birth, residence, and the like. Customer financial data could include income, credit information, past purchase information, and the like. Core vehicle data may include one or more features (e.g., make model, year, vehicle type, tire type, tire size, color, engine type and size, etc.), option data such as options included when manufactured or added at a dealer prior to sale (e.g., hitch installation, roof crossbar installation, etc.), interior screen availability and size, and compatibility with software or applications that may be installed on site or wirelessly. Core vehicle data may also include products or services such as vehicle protection, extended warranties, insurance, paint protection, etc.), local market information, dealer locations, inventory data, customer incentives, dealer rebates, trade-in value information, etc. Vehicle use data can include location data, tire and brake wear data, alignment data, sensor information (e.g., airbag sensors, coolant sensors, engine oil sensors, transmission sensors, etc.), and any other types of sensor data that may be useful in evaluating the condition of a vehicle as it operates. The data may be stored in one or more databases.

The embodiments described herein provide one or more AI models to facilitate data analysis and recommendations of products and services based on that analysis. One or more Al models are used by the system to analyze data to predict customer attraction to products and services based on customer data, vehicle manufacturer data, vehicle performance or operational data collected from sensors, and to generate customer profiles and product profiles that are further analyzed to provide the most attractive offers to customers. Notably, the information input into the systems and methods is stored and can be later used for fine tuning the AI model, acting as a feedback mechanism. In addition, the output generated by the AI model is also stored for similar feedback usage. Moreover, the output generated by the AI model one process of the overall method is used as input into one or more other processes of the method.

More specifically, embodiments of the invention enable (a) predictive maintenance through AI analysis of near real time vehicle data, including battery life and fuel mileage, using a long short-term memory model; (b) financial services recommendations through AI analysis of customer financial information, customer demographics, usage patterns (for time-differentiating contracts), and current and expected market conditions using a deep neural network model; (c) vehicle maintenance recommendations through AI analysis of near real time vehicle data, geo-positioning data (GPS), digital key use, etc. using a deep neural network model; and (d) suggesting new services to customers including detailed reasoning for the offers based in AI analysis demographics, usage patterns, customer preferences, chosen vehicle segment, and driving habits and using a large language model (LLM). There is currently no way to provide such functionalities through a single system because of the limitations of known systems in respect of the volume of data required, variations in data quality and format over time, and inability to support real-time processing. Furthermore, embodiments of the invention improve standard computer systems when used for massive data analysis, including demographic, geo-positioning, sensor, and financial data, as those systems are unable to automatically transform disparate types of data into formats usable for their algorithms. The invention enables the use of AI models to provide this functionality.

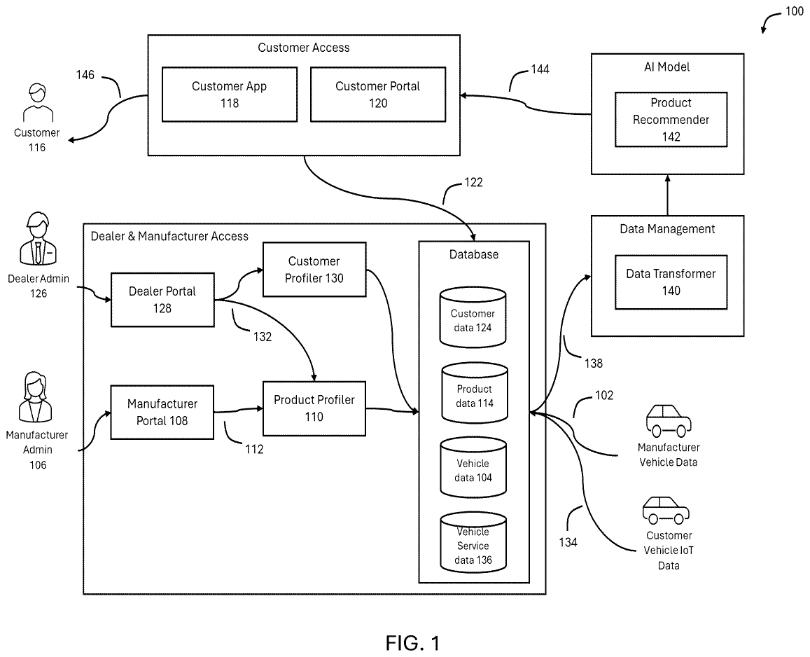

FIG. 1 is a logical flow diagram of an exemplary method 100 for vehicle product and service recommendation. Initially, manufacturer vehicle data (i.e., core vehicle data) is stored 102 to a vehicle data database 104. Manufacturer vehicle data may include point of sale information, pricing information, common service packages, parts information, discounts whether scheduled or as part of an employee discount, and any other suitable vehicle related information. The vehicle manufacturer 106 uses any suitable device (not shown in FIG. 1) to access a manufacturer portal 108. Via the manufacturer portal 108, the manufacturer 106 may use a product profiler 110 to analyze the vehicle data and configure 112 manufacturer products. These may include warranty packages, service packages, accessories, distinct services, and the like. The product profiler 110 stores data regarding the configured products into a product database 114. Customers 116 use an application 118 (e.g., a mobile phone application) or a customer portal 120, accessed using any suitable device (not shown in FIG. 1) to input customer data and preferences with customer consent, which is stored 122 in a customer database 124. Customer data may include survey data, transaction history (whether with the dealer 126, the manufacturer 106, or other entities), customer preferences, behavior data, data related to product or vehicle usage, point of sale data with the dealer 126, or any other suitable customer information. Vehicle dealers 126 uses any suitable device (not shown in FIG. 1) to access a dealer portal 128. Via the dealer portal 128, the dealer 126 may use a customer profiler 130 to analyze the customer data and configure 132 customer profiles and discount thresholds. The customer profiler 130 stores data regarding customer profiles and discount thresholds into the customer database 124 and/or the product database 114. Customer vehicle data (i.e., data gathered by vehicle sensors during performance) is stored 134 to a vehicle service database 136.

After all data is stored in databases 104, 114, 124, and 136, and as new data comes into the system, the data is managed and transformed 138 by a data transformer module 140. Data transformation may include, for example, changing (or matching) a customer name to a unique system ID, changing data formats from non-numeric to numeric and vice versa, estimating partial or missing information, and standardizing dates, numeric data, non-numeric data from the different data sources.

The data is mined and analyzed by one or more AI models, including a product recommender module 142. The product recommender module 142 may be a combination of multiple types of AI model and it analyzes customer data, vehicle data, etc. Based on the data analysis and real-time or near real-time data from vehicles or customers (i.e., via the customer app 118), the product recommender 142 determines the optimal products or services to offer to the customer 116.

After the product recommender 142 determines the optimal products or services to offer to the customer 116, the product recommender 142 generates 144 an offer of one or more products or services to the customer 116 and reasoning for how the recommended offers are provided to the customer 116. The customer 116 accesses 146 and accepts or rejects the offer via the customer application 118 or the customer portal 120. The customer selection for each proposed product or service is stored in the customer database 124 for use in evaluating future offers. If the customer 116 accepts the offer, the dealer portal 128 or the manufacturer portal 108 (or any other suitable system not shown in FIG. 1) generates the accounting information and contract details, communicates with the customer bank (information relating to such may be stored in the customer database 124) for billing purposes.

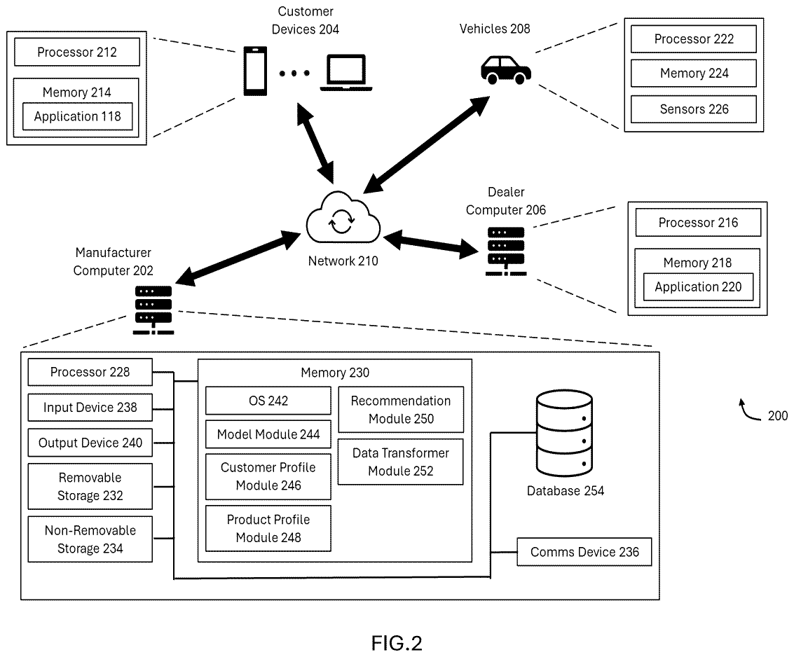

FIG. 2 is a diagram of an example system 200 for vehicle product and service recommendation. As shown in FIG. 2, the system 200 may include one or more manufacturer computers 202, one or more users (e.g., customers) associated with one or more customer computing devices 204, one or more dealer computers 206, and a plurality of vehicles 208, all interconnected and communicative through a network 210. The manufacturer computer 202 may include the manufacturer portal 108 (shown in FIG. 1). In some embodiments, the manufacturer computer 202 may include the product profiler 110, customer profiler 130, and databases 104, 114, 124, and 136, as well as data transformer 142, and/or product recommender 142 (all shown in FIG. 1). However, some or all of these components may alternatively be included in the dealer computer 206 along with the dealer portal 128 (shown in FIG. 1).

The customer devices 204 may access via the network 210 an application interface or website (e.g., the customer application 118 and/or the customer portal 120) hosted by the manufacturer computer 202 or the dealer computer 206. The customer devices 204 may call one or more active programming interfaces of the manufacturer computer 202 using the application interface to provide a user identifier, user demographic information, user financial information (e.g., credit card information or bank account information), user contact information, and the like. The customer devices 204 may also receive product or service recommendations and/or associated information such as advertising. Although the customer devices 204 shown in FIG. 2 are illustrative and shown as a mobile device and a laptop, the costumer devices 204 may be any suitable type of computing device including, but not limited to, desktop personal computers, laptop PCs, mobile phones, smartphones, personal digital assistants, tablets, game consoles, set-top boxes, wearable computers, e-readers, web-enabled televisions, or even devices installed within a vehicle 208. In certain aspects the customer devices 204 may include touch screen capabilities, motion tracking capabilities, cameras, microphones, vision tracking, etc. Moreover, to accommodate these capabilities, the customer devices 204 may include one or more processors 212 and memory 214 to store data and applications, such as customer application 118.

The dealer computer 206 may also be any type of computing device such as a mobile, desktop, and/or cloud computing devices, such as servers. The dealer computer 206 may be in communication with the manufacturer computer 202 via the network 210 to provide information to the manufacturer computer 202 associated with the vehicles 208 (e.g., service history at the dealer, vehicle inventory, service capacity and schedule, parts inventory, etc.) and/or to provide information via the network 210 to the customer devices 204 (e.g., the information shared with the manufacturer, account information, etc.). As such, the dealer computer 206 may include one or more processors 216 and memory 218. The memory 218 may store application program instructions that are loadable and executable by the processor 216, as well as data generated and/or analyzed during execution of these applications 220.

The vehicles 208 may include one or more processors 222, memory 224, and a plurality of sensors 226. The sensors 226 may be any type of sensor suitable for vehicle use including, but not limited to, pressure sensors that identify and gauge the pressure of the car's various fluids, including air, fuel, and oil; temperature sensors that monitor the engine's coolant, oil, and air temperatures; position sensors that determine where different parts are located to assist with, e.g., engine timing; speed sensors that detect the rotational speed of the wheels and axis for use in anti-lock braking systems; and level sensors that monitor the fluid levels in a variety of reservoirs. The memory 224 may store application program instructions that are loadable and executable by the processor 222 to monitor and analyze the data gathered by the sensors 226 and to transmit the data to the manufacturer computer 202 and/or dealer computer 206 via the network 210.

The manufacturer computer 202 may be any suitable computing device such as a cloud computing device or server and may be in communication with the dealer computer 206, the customer devices 204, and the vehicles 208 via the network 210. The manufacturer computer 202 may include one or more servers arranged in a cluster, as a server farm, or the like, and configured to host one or more websites such as the manufacturer portal 108, the dealer portal 128, and/or the customer portal 120, each accessible as is known in the art, such as via a web browser. In one embodiment, the manufacturer computer 202 includes one or more processors 228 and memory 230. The processor 228 may be implemented in hardware, software, firmware, or combinations thereof. Software or firmware implementations of the processor 228 may include computer-executable or machine-executable instructions written in any suitable programming language to perform the various functions described.

The memory 230 may store program instructions that are loadable and executable by the processor 228, as well as data generated during the execution of these programs. Depending on the configuration and type of manufacturer computer 202, the memory 230 may be volatile (such as random-access memory (RAM)) and/or non-volatile (such as read-only memory (ROM), flash memory, etc.). The manufacturer computer 202 may also include additional removable storage 232 and/or non-removable storage 234 including, but not limited to, magnetic storage, optical disks, and/or tape storage. The memory 230 may include multiple different types of memory, such as static random-access memory (SRAM), dynamic random-access memory (DRAM), or ROM. The memory 230, removable storage 232, and non-removable storage 234 are all examples of computer-readable storage media. For example, computer-readable storage media may include volatile and non-volatile, removable and non-removable media implemented in any method of technology for the storage of information such as computer-readable instructions, data structures, program modules, or other data.

The manufacturer computer 202 may also contain one or more communications devices 236 that allow the manufacturer computer 202 to communicate with the customer devices 204, vehicles 208, and dealer computer 206. The manufacturer computer 202 may also include input devices 238 such as a keyboard, a mouse, a pen or stylus, a voice input device, a touch input device, etc., and output devices 240 such as a display, speaker, printer, etc.

In more detail, memory 230 may include an operating system (OS) 242 and application programs or services for implementing the features disclosed herein, including a model module 244, a customer profile module 246 (which may coincide with the customer profiler 130 of FIG. 1), a product profile module 248 (which may coincide with the product profiler 100 of FIG. 1), a recommendation module 250 (which may coincide with the product recommender 142 of FIG. 1), and a data transformer module 252 (which may coincide with the data transformer 140 of FIG. 1). The various modules 244-252 may receive, transmit, and/or store information in a database 254, which may incorporate one or more of databases 104, 114, 124, and 136 of FIG. 1.

The model module 244 may use or include one or more types of AI model such supervised machine learning (ML) models, unsupervised ML models, large language/transformer models (generative AI models), neural networks, or any other multi-layer non-linear model. A neural network may include a recurrent neural network, long short-term memory recurrent neural network, a feed-forward neural network, or any other form of neural network. The model module 244 may train a machine learning model by adjusting weights of the machine learning model to optimize a cost comparison, sensor data monitoring, insurance rating, or similar such function. The model module 244 may finetune the one or more AI models using various training or learning techniques including, for example, backward propagation of errors, hyper parameter tuning (e.g., grid search, random search, Bayesian optimization), dropout regularization, model pruning, ensemble learning, or human in the loop training. The model module 244 may perform a number of generalization techniques (e.g., weight decays, dropouts, etc.) to improve the generalization capabilities of the one or more AI models being trained. In particular, the model module 244 may train the one or more AI models based on training sets that may be stored in the database 254. In some embodiments, the model module 244 may include computer logic utilized to provide desired functionality and may be implemented in hardware, firmware, and/or software controlling a processor, such as processor 228.

Additionally, or alternatively, the training set may be received from a feedback module (not shown), the customer devices 204, vehicles 208, and/or the dealer computer 206. In some embodiments, the model module 244 may refine or fine tune the one or more AI models using a value generated by the same AI models or across different AI models. For example, the model module 244 may determine that a supposed optimal price generated by one AI model in coordination with the product profile module 248 is less than a profitability threshold and unlikely to be purchased by a customer based on the output of a second AI model in coordination with the customer profile module 246. The feedback module may use that determination along with the model module 244 to modify the weights of the first AI model. As another example, the model module 244 may determine that a package (e.g., schedule maintenance package, predictive maintenance package, repair package, feature package, etc.) generated by one AI model in coordination with the recommendation module 250 includes too many line items or stretches over too long of a time period based on the output of a second Al model in coordination with the second AI model's analysis of the customer database 124. The feedback module may use that determination along with the model module 244 to modify the weights of the first AI model.

The customer profile module 246 may use a deep neural network (DNN) model to classify financial needs (e.g., compare loan vs. lease options for a given customer) based on customer information such as demographics, usage patterns (known or estimated from demographics), customer preferences, and selected vehicle segment. In an embodiment, the DNN learns and organizes features from the raw data and models complex relationships between inputs (the data) and outputs (financial services to offer). The core of the DNN model is the hidden layers, which are responsible for learning patterns, features, and relationship from raw input data. The layers consist of neurons that perform mathematical operations, like weighted summation of the inputs, and then pass the result of the operations to the non-linear activation function. The non-linear activation function allows the network to learn the complex patterns that cannot be captured by linear models. The neural network further learns from the errors through backpropagation by refining the weights and biases.

The product profile module 248 may use a long-short-term memory (LTSM) AI model based on near real-time vehicle data gathered from vehicles to provide predictive maintenance schedules to propose to customers. For example, the LTSM model may analyze the data in database 254 to determine remaining useful life of vehicle components, such as batteries, accelerators, brakes, clutches, etc. If a data point for a particular vehicle is below a threshold, the product profile module 248 may raise an alarm to the particular vehicle's owner and/or a specified dealer to set a service appointment.

The data transformer module 252 takes raw data that is often difficult to analyze and too vast in quantity to derive meaningful insight to be transformed into clean, usable data. For example, the data transformer module 252 may be constructive (i.e., the data transformation process adds, copies, or replicates data), destructive (i.e., the data transformation deletes fields or records), aesthetic (i.e., the data transformation standardizes the data to meet requirements or parameters), or structural (i.e., the data is reorganized by renaming, moving, or combining columns). In addition, the data transformer module 252 may carries out logical operations such as data aggregation, data normalization (e.g., standardization of data formats and ranges), data cleansing (e.g., converting misspellings, numerical values or filling in gaps of missing data), data smoothing (e.g., removing erroneous or noise from the data), data discretization (e.g., converting numerical values into intervals), or a combination of these or other data techniques in order to provide data for optimum use by the recommendation model 250.

The recommendation module 250 may use multiple AI models to recommend products and services to customers. For example, the recommendation module 250 may use a wide and deep ML algorithm, which is a hybrid AI approach combining content-based and collaborative filtering during analysis of customer demographics, usage patterns (known or estimated from demographics), customer preferences, and ratings. This is a two-step analysis in which a wide component (linear models) and a deep component (non-linear models, typically neural network) converge at a set of recommended products and services. The wide model captures memorization of specific feature combinations such that it essentially learns how to match new data with already seen examples like a traditional linear model. The deep model learns generalization and complex patterns from the data. It uses neural networks to capture non-linear relationship between features, allowing the model to generalize better to unseen combination of features and to model abstract patterns in the data. The outputs from wide and deep models are combined typically through concatenation or addition before being passed to final prediction layer. An LLM (i.e., a generative AI model) may then analyze details of the set of recommended products and services and details of a given customer to generate marketing/sales materials that express the benefits of the recommended products and services. The LLM first understands the user's preferences and usage patterns. Then it looks for context in the customer's information. It interprets what is being requested, such as understanding the attributes, entities, etc. It also considers customer preferences to narrow down relevant recommendations. The LLM assesses the attributes or entities of the recommended items. It uses historical information about the customer's preferences or past behaviors to generate a personalized reason. LLM also incorporates contextual aspects such as trending topics, seasonal relevance or current events.

The customer devices 204, vehicles 208, the one or more dealer computers 206, and the manufacturer computer 202 may be configured to communicate via the network 210, wirelessly or wired. The network 210 may include, but is not limited to, any of a combination of different types of suitable communications networks such as broadcasting networks, cable networks, public networks, private networks, wireless networks, cellular networks, or any other suitable private and/or public networks. Further, the network 210 may have any suitable communication range associated therewith and may include, for example, global networks (e.g., the Internet), metropolitan area networks, wide area networks, local area networks, or personal areas networks. In addition, the network 210 may include any types of medium over which network traffic may be carried including, but not limited to, coaxial cable, twisted-pair wire, optical fiber, hybrid fiber coaxial cable, microwave terrestrial transceivers, radio frequency communication mediums, white space communication mediums, ultra-high frequency communication mediums, satellite communication mediums, or any combination thereof.

The example architecture and computing devices shown in FIG. 2 are provided by way of example only. Numerous other operating environments, system architectures, and device configurations are possible. Accordingly, embodiments of the present invention should not be construed as being limited to any particular operating environment, system architecture, or device configuration.

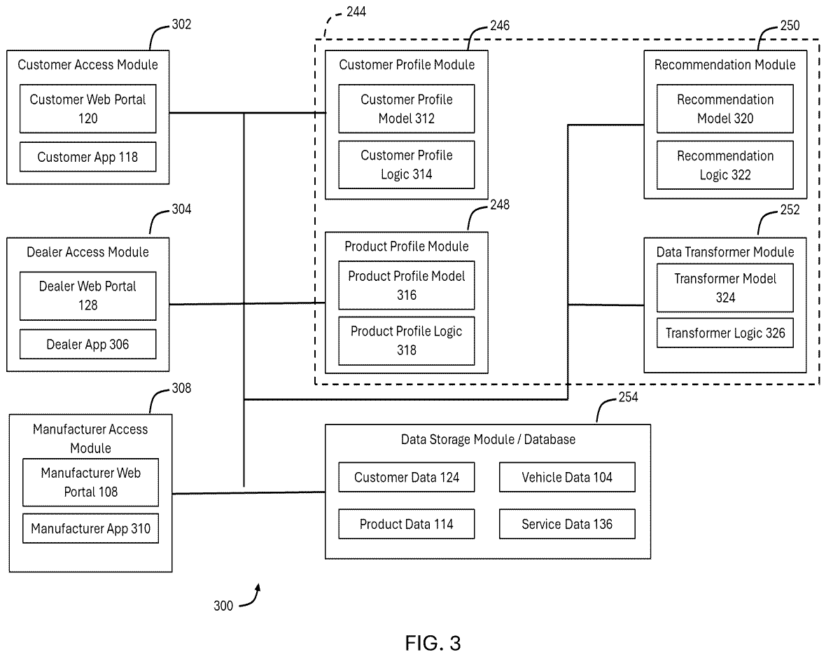

FIG. 3 is a logical architecture 300 of the modules shown in FIG. 2. A customer access module 302 governs access by customers 116 (shown in FIG. 1), including past, present, and potential customers, to the customer web portal 120 and the customer application 118. The customer access module 302 provides authentication checks on customer identification and login and protects sensitive information transmit to and from the customer via the web portal 120 and application 118. The authentication and information protection methodologies may be any of the sort known in the art.

A dealer access module 304 governs access by vehicle dealers 126 (shown in FIG. 1) to the dealer web portal 128 and a dealer application 306. A manufacturer access module 308 governs access by the vehicle manufacturers 106 (shown in FIG. 1) to the manufacturer web portal 108 and a manufacturer application 310. As with the customer access module 302, the dealer access module 304 and manufacturer access module 308 provide authentication checks on dealer and manufacturer administrator identification and login and protects sensitive information transmit to and from the customer, manufacturer, and dealer via the web portals 128 and 108 and applications 306 and 310. The authentication and information protection methodologies may be any of the sort known in the art.

The data storage module or database 254 includes multiple databases, including the customer database 124, product database 114, vehicle database 104, and vehicle service database 136. These databases may be integrated into a single database, partitioned such that each appears as a virtual database within the same database, or implemented as entirely separate databases. Moreover, these databases may be stored on separate computers or integrated into the same computer, or in separate memory modules or integrated into the same memory module.

The model module 244 may include the customer profile module 246, product profile module 248, recommendation module 250, and data transformer module 252. These modules may be implemented via a single AI model, such as an ML model or LLM, or may be implemented separately using different types of AI models.

The customer profile module 246 may include the customer profiler 130 (shown in FIG. 1) which may include a customer profile model 312 and customer profile logic 314. In an embodiment, the customer profile model 312 is a DNN although any suitable type of AI model may be used. The customer profile logic 314 includes logic that generates input data in a selected format to enable the customer profile model 312 to analyze the data as described above. The logic 314 may also format the output of the model 312 as input into the recommendation module 250, for example.

The product profile module 248 may include the product profiler 110 (shown in FIG. 1) which may include a product profile model 316 and product profile logic 318. In an embodiment, the product profile model 316 is an LTSM. The product profile logic 318 includes logic that generates input data in a selected format to enable the product profile model 316 to analyze the data as described above. The logic 318 may also format the output of the model 316 as input into the recommendation module 250, for example.

The recommendation module 250 may include the product recommender 142 (shown in FIG. 1) which may include a recommendation model 320 and recommendation logic 322. In an embodiment, the recommendation model 320 is a combination of a wide and deep AI algorithm and an LLM. The recommendation logic 322 includes logic that enables the recommendation model 320 to generates input data in a selected format to enable the wide and deep algorithm to analyze the data as described above. The logic 326 may also format the output of the wide and deep algorithm as input into the LLM. The logic 326 may also format the output of the LLM into a preexisting template or messaging tool for use in sending offers and/or reminders to customers.

The data transformer module 252 may include the data transformer 140 (shown in FIG. 1) which may include a transformer model 324 and transformer logic 326. In an embodiment, the transformer model 324 takes raw data that is often difficult to analyze and too vast in quantity to derive meaningful insight to be transformed into clean, usable data. The transformer model 324 may be constructive (i.e., the data transformation process adds, copies, or replicates data), destructive (i.e., the data transformation deletes fields or records), aesthetic (i.e., the data transformation standardizes the data to meet requirements or parameters), or structural (i.e., the data is reorganized by renaming, moving, or combining columns). The transformer logic 326 carries out logical operations such as data aggregation, data normalization (e.g., standardization of data formats and ranges), data cleansing (e.g., converting misspellings, numerical values or filling in gaps of missing data), data smoothing (e.g., removing erroneous or noise from the data), data discretization (e.g., converting numerical values into intervals), or a combination of these or other data techniques in order to provide data for optimum use by the recommendation model 250.

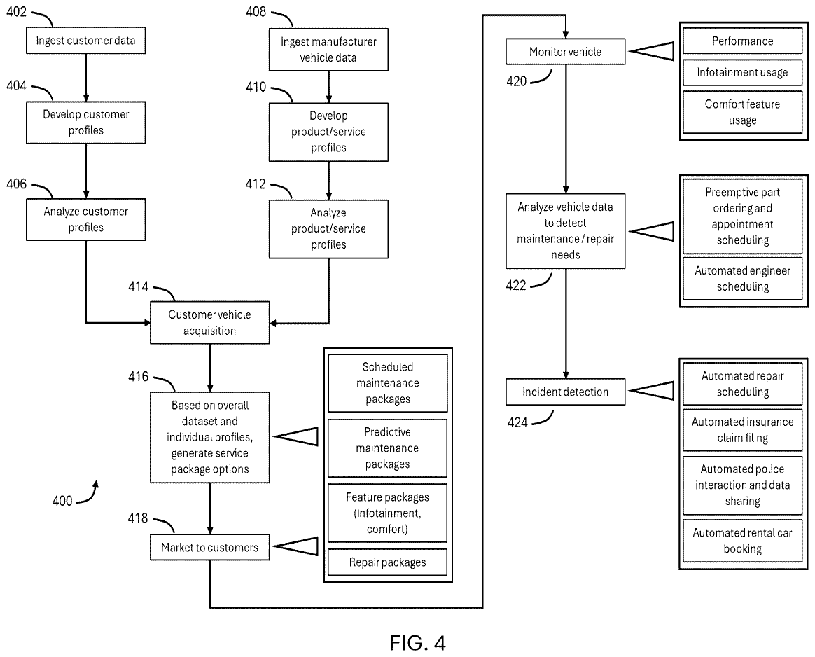

FIG. 4 is a flowchart 400 illustrating an example method 400 for vehicle product and service recommendation using the system and architecture shown in FIGS. 1-3.

Initially, customer data, such as demographic information, customer preferences, customer financial information, etc., is ingested 402 into database 254 and, more specifically, into customer database 124. This may be done through any process known in the art but also through the customer access module 302, including the customer web portal 120 and/or the customer application 118. The customer profile module 246 then generates 404 customer profiles using the DNN as described above. The customer profile model 312 may also analyze 406 the customer profiles to determine suitable financial services to offer, for example.

In addition, manufacturer vehicle data, such as features, financing options, etc., is ingested 408 into database 254 and, more specifically, into vehicle database 104. This may be done through any process known in the art but also through the manufacturer access module 308, including the manufacturer web portal 108 and/or the manufacturer application 310. Vehicle data may also be submitted by dealers through the dealer access module 304, including the dealer web portal 128 and/or the dealer application 306. The product profile module 248 then generates 410 product and service profiles using the LTSM as described above. The product profile model 316 may also analyze 412 the product profiles to determine features to offer, for example.

The data transformer module 252, including the transformer model 324 and transformer logic 326, prepares the data for optimal use by the recommendation module 250 and the analysis modules 406, 412, 422 but not limited to these modules

During the shopping experience, customers may elect to use 414 the customer web portal 120 and/or customer application 118 to view and select, and even to buy, a vehicle. As part of the shopping process, the recommendation module 250 may analyze the shopper customer's information at different points in the process. For example, when the customer initiates the shopping process, the customer access module 302 may collect the customer's location (e.g., zip code) and use that in coordination with the customer database 124 to identify some demographic and/or financial information of the customer. That information may be used to apply a customer profile by the customer profile module 246. The customer profile module 246 may generate a profile of the customer, which may then be used by the product profile module 248 to generate 416 proposed products and services. The recommendation module 250 then generates 418 marketing information and presents it to the user as part of the shopping experience. The recommendations could include, for example, specific vehicles or vehicle configurations, accessories, scheduled maintenance packages (i.e., at 5,000-mile increments), predictive maintenance packages based on sensor monitoring, repair packages in case of accidental damage, or feature packages such as comfort and entertainment features.

After the customer acquires the vehicle (via purchase or lease), the vehicle is monitored 420 by the system 200. For example, the vehicle sensors 226 may collect data on the vehicle's performance (e.g., battery or fuel range, tire pressure, fluid pressures and temperatures, etc.) and transmit the data to the manufacturer computer 202 via network 210. The manufacturer computer 202 may store the vehicle data in the vehicle service database 136. The vehicle data may also include performance data such as miles per gallon or the battery performance. Moreover, the vehicle data may include comfort or feature usage information such as frequent radio stations, common environment settings like temperature, or whether and when the seat heaters are enabled.

As the vehicle data is stored, it may be analyzed 422 by the manufacturer computer processor 228 and/or instructions stored to the removable or non-removable storage 232 or 234. The analysis may inform the manufacturer computer 202 that the vehicle is nearing the need for service, such as based on a pre-established mileage, when the sensors indicate that the tires or brakes are nearing replacement, etc. The manufacturer computer 202 may determine from analyzing such information that the customer may potentially be interested in a new subscription entertainment or feature service or accessory. Specifically, the product profile module 248 may perform these analyses, store the results in the product database 114, and send the results to the recommendation module 250. The recommendation module 250 then generates marketing information and presents it to the user as part of the maintenance experience. The recommendations could include, for example, the option to preemptively order parts, schedule services at the dealer, subscribe to new services, or order new accessories. In addition, the recommendation module 250 may automatically engage a dealer computer system (not shown) in order to automatically schedule service engineer or technicians if the customer accepts a recommendation for parts or services. In addition, the recommendation module 250 may automatically engage a rental car company or ride sharing company to provide the customer with car service during his or her vehicle appointment.

In addition, during the ownership experience, vehicle sensor data may be analyzed to indicate an accident. The vehicle itself may detect an incident or the manufacturer computer 202, e.g., the product profile module 248, may detect 424 the incident via the vehicle data transmitted and stored in the vehicle database 136. When an incident is detected, the recommendation module 250 may generate suggested services and present it to the user as part of the repair experience. The recommendations could include, for example, the option to engage a dealer computer system (not shown) in order to automatically schedule repairs, order parts, and schedule engineer or technicians if the customer accepts. In addition, the recommendation module 250 may automatically engage a rental car company or ride sharing company to provide the customer with car service during his or her vehicle repair. The incident data, proposed repairs and parts, and whether the customer accepted the recommendations may be stored in the customer database 124 and/or the vehicle database 104.

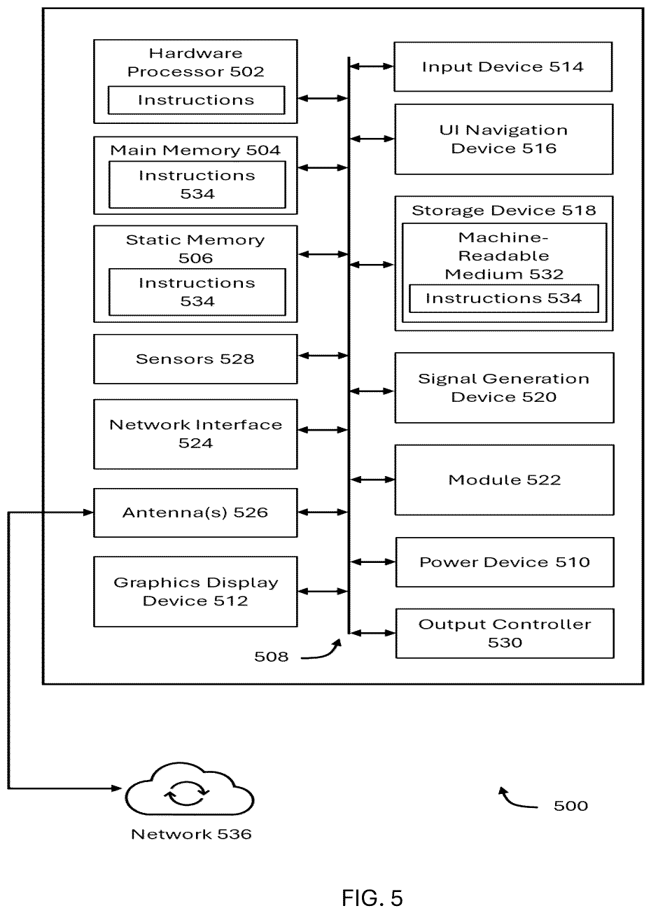

FIG. 5 is a block diagram of an example machine 500 (e.g., the manufacturer computer 202, dealer computer 206, customer device 204, or vehicle 208 of FIG. 2) or system upon which any of the techniques and processes discussed herein may be performed. In a networked environment, the machine 500 may operate in the capacity of a server, a client, or both in a server-client network environment. In an example, the machine 500 may act as a peer machine in Wi-Fi direct, peer-to-peer (P2P) or other distributed network environments. The machine 500 may be a server, a personal computer, a tablet, a set-top box, a personal digital assistant, a mobile telephone, a smartphone, a wearable computer device, a web appliance, a vehicle information system, or any machine capable of executing instructions (sequential or otherwise) that specify actions to be taken by that machine. While only a single machine is illustrated, the term “machine” shall also be taken to include any collection of machines that individually or jointly execute a set of instructions to perform any of the methods or processes described herein, such as cloud computing, software as a service, or other computer cluster configurations.

Examples as described herein may include or operate on logic or a number of components, modules, or mechanisms. Modules are tangible entities (e.g., hardware) capable of performing specified functions when operating. A module includes hardware, which may be specifically configured to carry out a specific operation, or may include configurable parts, and a computer-readable medium containing instructions that cause the module to carry out a specific operation.

The machine (e.g., computer system) 500 may include a hardware processor 502 (e.g., a processing unit or chip, a graphics processing unit, a hardware processor core, or any combination thereof), a main memory 504, and a static memory 506, all communicatively coupled via a bus 508. The machine 500 may also include a power management device 510, a graphics display device 512, one or more input devices 514, and one or more UI navigation devices 516. The input device 514 and navigation device 516 may be integrated such as through a touch screen, for example, or may be independent of each other. The machine 500 may further include a storage device 518, a signal generation device 520 such as an emitter or speaker, one or more modules 522, a network interface device 524 or transceiver coupled to one or more antennae 526, and one or more sensors 528 (e.g., a global positioning system sensor, a compass, an accelerometer, etc.). The machine 500 may include an output controller 530, such as a serial connection to communicate with or control one or more peripheral devices (e.g., a printer, a card reader, etc.)).

The storage device 518 may include a machine-readable medium 532 on which is stored one or more sets of data structures and/or instructions 534 (e.g., software) embodying by any of the methods or processes described herein. The instructions 534 may also reside, at least partially, within the main memory 504 or the static memory 506. Alternatively, the storage device 518 may constitute machine-readable media.

The modules 522 may carry out or perform any of the methods or processes described above (e.g., method 400 of FIG. 4). The modules 522 may be included in the manufacturer computer 202, e.g., as or including the model module 244, customer profile module 246, product profile module 248, recommendation module 250, or data transformer module 252.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices, like electrically programmable read-only memory or electrically erasable programmable read-only memory, and flash memory devices, magnetic disks, such as internal hard disks and removable disks, magneto-optical disks, and CD-ROM and DVD-ROM disks.

The instructions 534 may further be transmitted or received over a communications network 536 using a transmission medium via the network interface device/transceiver 524 utilizing any one of a number of transfer protocols such as frame relay, internet protocol, transmission control protocol, user datagram protocol, hypertext transfer protocol, etc. Example communications networks may include a local area network, a wide area network, a packet data network (e.g., the Internet), mobile telephone networks (e.g., cellular networks), plain old telephone (POTS) networks, wireless data networks, and peer-to-peer networks, among others.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed. It is understood that the above descriptions are for purposes of illustration and are not meant to be limiting.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method for generating optimized product and service recommendations to customers, the method comprising:
ingesting, from a plurality of disparate data sources, customer data, manufacturer vehicle data, and vehicle operating data collected by one or more sensors of a vehicle associated with a given customer in a near real-time manner;
transforming, by a data transformer module, at least a portion of the ingested customer data, manufacturer vehicle data, an vehicle operating data into transformed data in a selected format for input into artificial intelligence (AI) models, wherein transforming comprises:
generating unified identifiers across the disparate data sources;
converting heterogeneous data types into structured input representations formatted for processing by multiple AI models;
estimating missing sensor values; and
standardizing temporal data across multiple data streams to align the customer data, manufacturer vehicle data, and vehicle operating data into a format usable by multiple AI models enabling cross-model interoperability and real-time inference;
generating a plurality of customer profiles using a first AI model based on the transformed data corresponding to the customer data;
generating a plurality of product and service offerings using a second AI model based on the transformed data corresponding to the manufacturer vehicle data;
generating structured output data from at least one of the first AI model and the second AI model and providing the structured output data as input to a third AI model;
generating a plurality of recommended products and services and a detailed reasoning for the recommendations for a given customer using the third AI model based on the transformed data associated with the given customer profile, other customer profiles, and the plurality of product and service offerings;
detecting one or more vehicle conditions based on the near real-time sensor data and dynamically triggering generation of the plurality of recommended products and services in response to the detected vehicle conditions;
automatically initiating, based on the detected one or more vehicle conditions and the plurality of recommended products and services, at least one machine-implemented operational process including at least one of scheduling a vehicle service operation, generating a maintenance workflow executed by a dealer or manufacturer system, and initiating a system-level process to procure parts or allocate services resources; and
transmitting, via a network interface, an offer including at least one recommended product or service to a customer device and storing an acceptance or rejection of the offer for use in retraining at least one of the AI models by updating model parameters for subsequent recommendations inference cycles to enable real-time generation of recommendations based on continuously updated sensor data.

2. The method of claim 1, wherein the plurality of product and service offerings includes scheduled maintenance packages, predictive maintenance packages, feature packages, and repair packages.

3. The method of claim 1, wherein the customer data includes demographic data, financial data, and vehicle use data, and wherein at least a portion of the vehicle operating data is collected by the one or more sensors.

4. The method of claim 1, wherein the manufacturer vehicle data includes core vehicle data, option data, and local market information.

5. The method of claim 1, further comprising storing the customer profiles and product profiles in one or more databases and storing the generated recommendations and the acceptance or rejection for use in refining or fine-tuning at least one of the AI models.

6. The method of claim 1, further comprising analyzing near real-time vehicle data included in the vehicle operating data collected by the one or more sensors using a deep neural network model to provide predictive maintenance recommendations based on detected vehicle conditions derived from the near real-time vehicle data.

7. The method of claim 1, further comprising analyzing customer financial information using a deep neural network model to provide financial services recommendations.

8. The method of claim 1, further comprising analyzing vehicle use data included in the vehicle operating data collected by the one or more sensors using a long-short-term memory model to provide vehicle maintenance recommendations.

9. The method of claim 1, wherein generating the detailed reasoning for the recommendations for the given customer uses a large language model.

10. A system for generating optimized product and service recommendations to customers, the system comprising:
a customer profile module configured to generate a plurality of customer profiles using a first AI model based on transformed customer data that has been processed to include unified identifiers across disparate data sources and structured input representations formatted for processing by multiple AI models;
a product profile module configured to generate a plurality of product and service offerings using a second AI model based on transformed manufacturer vehicle data that has been processed to include conversion of heterogeneous data types into structured input representations and temporal standardization across data streams;
a recommendation module configured to generate a plurality of recommended products and services and a detailed reasoning for the recommendations for a given customer using a third AI model based on the given customer profile, other customer profiles, manufacturer vehicle data, and structured output data generated by at least one of the customer profile module or the product profile module and provided as input to the recommendation module to enable multi-model inference;
one or more databases configured to store the customer profiles and product profiles;
a network interface configured to communicate with customer devices, dealer computers, and manufacturer computers; and
a data transformer module configured to perform transformation operations on at least customer data, manufacturer vehicle data, and vehicle operating data collected by one or more sensors of a vehicle, to generate transformed data in a selected format for input into at least one of the customer profile module, the product profile module, or the recommendation module, wherein the transformation operations include generating unified identifiers across disparate data sources, converting heterogeneous data types into structured input representations formatted for processing by the multiple AI models within the system, estimating missing sensor values, and standardizing temporal data across multiple data streams, and wherein the recommendation module is further configured to generate the plurality of products and services in response to vehicle conditions detected from continuously updated near real-time sensor data collected from the vehicle.

11. The system of claim 10, wherein the customer profile module uses a deep neural network model to classify financial needs based on customer information.

12. The system of claim 10, wherein the product profile module uses a long-short-term memory model to analyze near real-time vehicle data for predictive maintenance recommendations.

13. The system of claim 10, wherein the recommendation module uses a wide and deep machine learning algorithm to analyze customer demographics, usage patterns, and preferences.

14. The system of claim 10, wherein the recommendation module sues a large language model to generate marketing information for the recommended products and services.

15. The system of claim 10, wherein the customer profile module is configured to analyze customer profiles to determine suitable financial services to offer.

16. The system of claim 10, wherein the product profile module is configured to analyze customer profiles to determine suitable financial services to offer.

17. A system for generating optimized product and service recommendations to customers, the system comprising:
one or more databases configured to store customer data, manufacturer vehicle data, vehicle operating data, and product and service data;
a data transformer module configured to:
perform transformation operations on the data stored in the one or more databases;
generate unified identifiers across disparate data sources;
convert heterogeneous data types into structured input representations formatted by multiple AI models;
estimate missing sensor values; and
standardize temporal data across multiple data streams to enable real-time processing of the data;
a customer profile module configured to generate a plurality of customer profiles using customer profile logic and a first AI model based on the customer data transformed by the data transformer module to include the unified identifiers and structured input representations;
a product profile module configured to generate a plurality of product and service offerings using product profile logic and a second AI model based on the manufacturer vehicle data transformed by the data transformer module to include conversion of heterogeneous data types and temporal standardization across data streams; and
a recommendation module configured to generate a plurality of recommended products and services and a detailed reasoning for a given customer using recommendation logic and a third Al model based on the given customer profile, other customer profiles, manufacturer vehicle data, and the plurality of product and service offerings, wherein at least one of the customer profile logic or the product profile logic is configured to generate structured output data that is provided as input into the recommendation module to enable multi-stage inference across the system, and wherein the recommendation module is further configured to dynamically update the generated recommendations based on changes in near real-time data collected by one or more sensors of a vehicle associated with the given customer and the system is configured to transmit an offer including at least one recommended product or service to a customer device and to store acceptance or rejection of the offer for use in retraining at least one AI model by updating model parameters for subsequent inference cycles.

18. The system of claim 17, wherein the first AI model is a deep neural network (DNN) model and the customer profile logic is configured to generate input data in a selected format to enable the DNN model to create customer profiles as a function of the input data.

19. The system of claim 17, wherein the second AI model is a long-short-term memory (LTSM) model and the product profile logic is configured to generate input data in a selected format to enable the LTSM model to create product profiles as a function of the input data, including near real-time vehicle operating data collected by the one or more sensors.

20. The system of claim 17, wherein the data transformer module comprises a transformer model configured to perform one or more of constructive, destructive, aesthetic, and structural functions including generating the unified identifiers, converting the heterogeneous data types into the structured input representations, estimating the missing sensor values, and standardizing the temporal data across the multiple data streams.
